(19) United States
(12) Patent Application Publication
(10) Pub. No.: US 2008/0088174 A1
(43) Pub. Date: Apr. 17, 2008

(54) Wheel Studs

(76) Inventors: Denis Lantsbury, West Sussex (GB); Frank Hauser, West Sussex (GB)

Correspondence Address: Levy & Grandinetti, P.O. Box 18385, Washington, DC, 20036, US

(21) Appl. No.: 10/555,650

(22) PCT Filed: May 7, 2004
(86) PCT No.: PCT/GB04/02003

§ 371 Date: Jun. 18, 2007

(30) Foreign Application Priority Data
May 9, 2003 (GB) 0310749.7

(51) Int. Cl. B60B 15/24

(52) U.S. Cl. 301/44.2; 301/43; 301/44.1; 301/44.3

(57) ABSTRACT

A vehicle wheel (1) provided with a plurality of studs (2) which extend radially from a rim of the wheel. The studs are parabolic or substantially parabolic in cross-section in a plane normal to the axis of rotation of the wheel and generally parallel to the rolling direction of the wheel which enables the studs to ride over the surface during rotation of the wheel without removing material from the surface.

This invention relates to novel studs for use with a wheel, a wheel provided with such studs, and a vehicle provided with such wheels, for use especially, but not exclusively, with a golf trolley, cart or buggy.

Golf trolleys commonly comprise a substantially triangular chassis provided with wheels at the lower corners, and a support for a bag of golf clubs. Such trolleys are conventionally provided with a handle and are pushed or pulled along as the player traverses a course.

On many golf courses the use of trolleys may be banned during bad weather or damp conditions. This is because the wheels of the trolley can damage the surface of the course and leave muddy tracks.

This problem is encountered with any wheeled vehicle used on a golf course, for example a golf buggy for transporting the players.

The present invention is intended to solve or at least alleviate these and other problems.

In one aspect, the present invention provides a vehicle wheel provided with a plurality of studs which extend radially from a rim of the wheel, the vehicle wheel being characterised in that at least some of the studs are parabolic or substantially parabolic in cross-section in a plane normal to the axis of rotation of the wheel and generally parallel to the rolling direction of the wheel.

In a preferred embodiment, all studs are parabolic in cross-section.

This parabolic shape enables the studs to ride over the surface during rotation of the wheel, substantially, without removing material from the surface.

“Riding over” the surface may include penetration of the surface or may simply cause an impression on the surface.

Each stud is preferably paraboloid or substantially paraboloid in shape.

In a preferred embodiment, the vehicle is a golf trolley adapted to carry a bag of golf clubs. In an alternative embodiment, the vehicle is a golf buggy adapted to carry golfers and their clubs. In a still further embodiment, the vehicle is an alternative vehicle which, in use, traverses turf or another penetrable medium.

In one construction, the studs are attached directly to the rim of the vehicle wheel. The studs may be integrally formed with the wheel, or may be removably or permanently attached to the wheel rim. In a preferred construction, the studs are provided on an elongate base, which is adapted to be fitted to the outer surface of the wheel rim.

In a preferred construction, the base comprises a strip of resilient material e.g. a rubber or rubber-like compound. The strip may comprise a continuous loop or may comprise a length having attachment means at each end; in this way, the base can be wrapped around the wheel rim and held in place by the attachment means. The attachment means may comprise any suitable mechanism, for example press studs or two opposing surfaces of a hook and loop fastener. Other known attachment mechanisms can, however, be employed.

The studs and the base may be constructed from a single piece of resilient material. In a preferred construction, the base and studs are constructed from a PVC compound of Shore A74 hardness or similar material. With this arrangement, the single piece can be injection moulded during manufacture.

In an alternative embodiment, the studs are individually constructed and attached to the base. In this embodiment, the studs may comprise a base portion and a body portion. The base portion of each stud may be provided with a male portion of an attachment means, and the body portion may be provided with a female portion of the attachment means. The base portion may be disposed adjacent the inner surface of the base, with the male portion of the attachment means protruding through an aperture provided in the base. The body portion may be attached to the base portion via the attachment means which protrudes through the base portion.

In a preferred embodiment, the base has substantially the same dimensions as those of the outer peripheral rim surface of the wheel. The base may be provided with approximately 34 studs, which are formed in two offset rows of 17 studs, substantially parallel to the side of the base. Other numbers of studs may, however, be provided.

Preferably, the base is adapted to be fitted to a golf trolley wheel, and may be between substantially 70 mm and 125 mm in width, and preferably 70 mm to 75 mm in width. The rows of studs are typically substantially 30 mm to 50 mm apart, and preferably 36 mm apart, with substantially 35 mm to 80 mm, and preferably 41 mm between each stud in a row. The rows can be offset so that the studs in one row are substantially half-way along the gap between the studs in the adjacent row. Other arrangements can, however, be adopted.

In one construction, the ends of the base are angled at approximately 45 degrees to the sides. This is to enable the base to be secured in position without the attachment means interfering with the position of any of the studs.

The studs may be between substantially 20 mm and 45 mm and preferably 23 mm to 30 mm in length, and 15 mm to 30 mm wide at their base. Preferably, the studs are substantially paraboloid in shape.

In another aspect, the invention provides a set of studs for mounting on a vehicle wheel and which, when so mounted, extend substantially radially from a rim of the wheel, each stud being substantially paraboloid in shape.

In a further aspect, the invention provides a base for mounting on the rim of a vehicle wheel for use with a golf course traversing or other vehicle, the base including a plurality of studs upstanding from one surface, the base being characterised in that when the base is mounted on the rim of a vehicle wheel each stud is parabolic in shape in cross-section in a plane normal to the axis of the wheel and parallel to its rolling direction.

The invention further includes a golf course traversing vehicle provided with wheels having a plurality of studs as described above.

The invention will now be described by way of example only with reference to the accompanying diagrammatic drawings, in which:

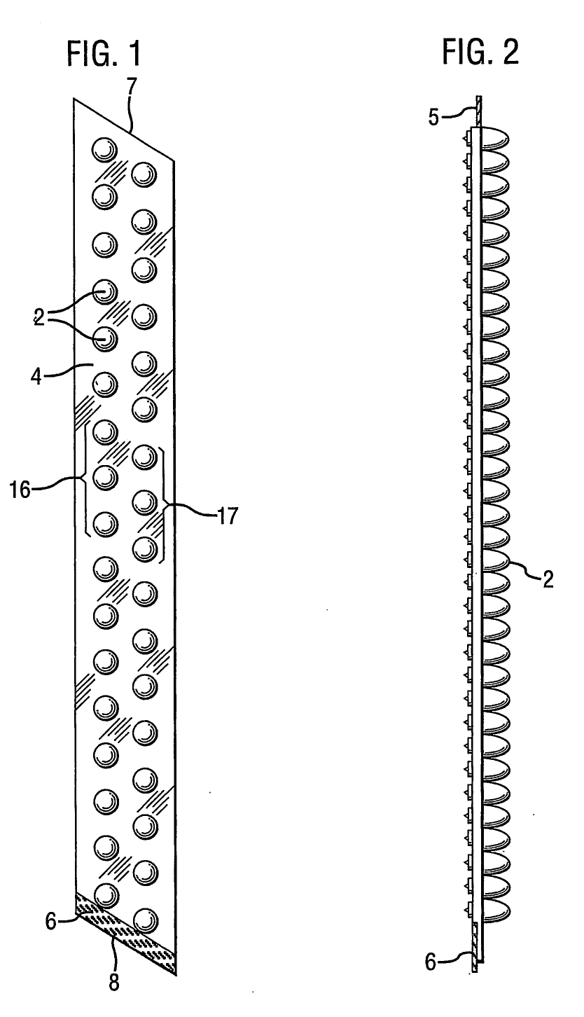

FIG. 1 is a plan view from above of apparatus according to the present invention;

FIG. 2 is a side view of the apparatus as shown in FIG. 1;

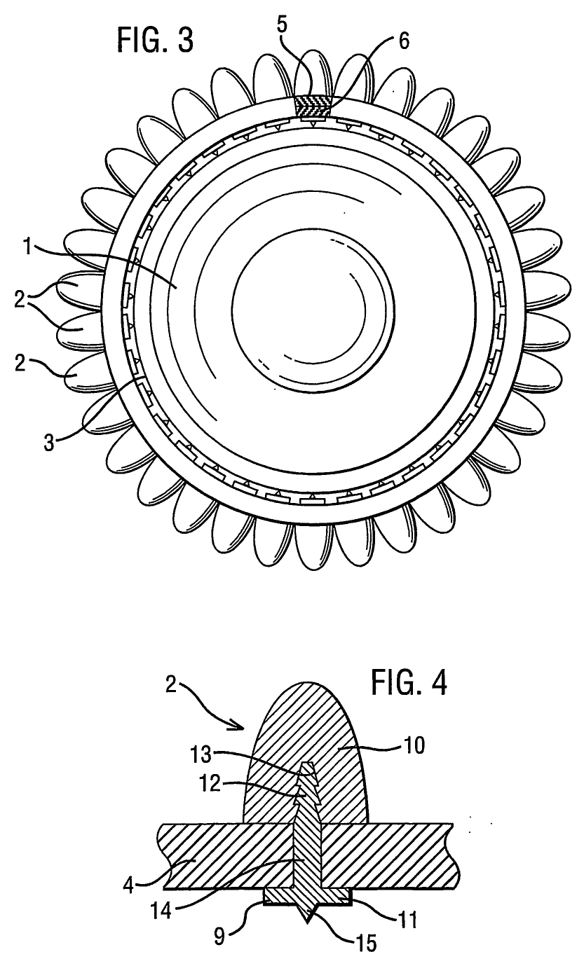

FIG. 3 is a side view of the apparatus as shown in FIG. 1 in use; and

FIG. 4 is a cross-sectional side view of a part of the apparatus as shown in FIG. 1;

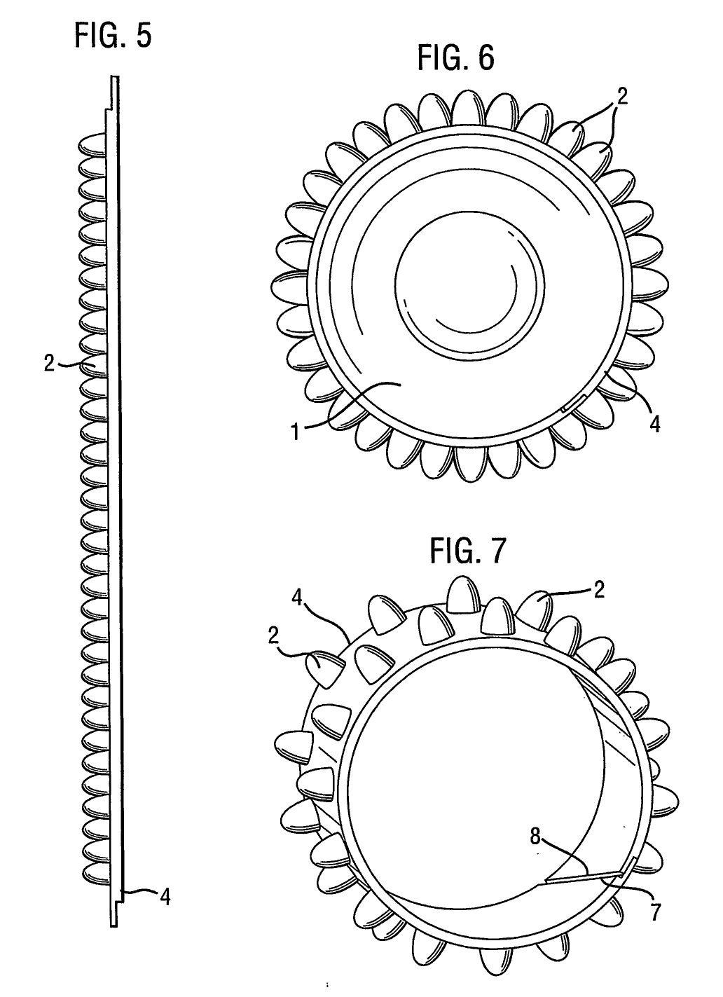

FIG. 5 is a side view of a further embodiment according to the present invention;

FIG. 6 is a side view of the apparatus of FIG. 5 in use; and

FIG. 7 is a side perspective view of the apparatus of FIGS. 5 and 6.

As shown in FIGS. 1 to 4, a golf trolley wheel 1 is provided with a plurality of studs 2 which extend radially from a rim 3 of the wheel 1 and are adapted to ride over turf over which the wheel is rotated in use. In a plane normal to the rotational axis of the wheel and parallel to the rolling direction of the wheel each stud is parabolic in cross section (as shown in FIG. 4). When the wheel is rotated in use, the studs exit the turf substantially without removing material from the turf.

As shown in FIGS. 1 and 2, the studs 2 are mounted on an elongate base 4, which is constructed from a resilient material. The material of the base may comprise a rubber or rubber-like compound. The base is provided with the two opposing surfaces of a hook and loop fastener 5 and 6 at either end. The base is further provided with angled end edges 7 and 8. With this arrangement, the surfaces 7 and 8 can be attached together, without a gap being present between the studs 2. In use, the base 4 is wrapped around the wheel rim 3, as shown in FIG. 3.

As shown best in FIG. 4, the studs comprise a base portion 9 and a body portion 10. The body portion is paraboloid in shape. The base portion comprises a collar 11 and a male portion 12 of a connection mechanism. The body portion 10 is provided with a female portion 13 of the connection mechanism. The base portion 9 is disposed on the inner surface of the base 4, with each male portion 12 extending through an aperture 14 provided in the base 4. The body portion is disposed on the outer surface of the base 4, and the stud 2 is held in place by means of the connection mechanism being forced together. The base portion 9 is further provided with an extension 15, which is adapted to purchase the wheel rim 3, as shown in FIG. 3, to help keep the base 4 in position during use.

In an alternative embodiment, the base 4 comprises a continuous loop with the studs projecting upwardly from one surface of the base 4.

The base 4 is substantially 70 mm to 125 mm in width, and is provided with 34 studs 2, which are arranged into two rows 16 and 17. The rows 16 and 17 are substantially 36 mm apart, with substantially 41 mm between each stud 2. The rows 16, 17 are offset so that the studs 2 in one row are substantially half-way along the gap between the studs 2 in the adjacent row. The body portions 10 of the studs 2 are substantially 23 mm in length, and 20 mm wide at their base.

In an alternative embodiment, shown in FIGS. 5 to 7, the base 4 and studs 2 are integrally formed from a single length or loop of injection moulded PVC of Shore A74 hardness or similar. The PVC may alternatively be formed by rotational moulding. Alternatively still the studs 2 may be adhered to the base 4 using suitable adhesive.

In this embodiment, a mechanical connection mechanism between the stud 2 and the base 4 is not required.

As can be seen best in FIG. 7, the surfaces 7 and 8 of the base 4 are attached together, for example by ultrasonic welding to form a continuous loop with the studs 2 projecting from one surface of the base 4.

In a further alternative embodiment (not shown), the studs comprise a body portion substantially similar in shape to body portion 10 as shown in the Figures; however, the body portions are each provided with a bolt extension from its base, adapted to be received in bolt holes formed in the wheel rim. With this arrangement, the studs can be screwed into place when needed and removed when no longer required. It will be appreciated that with this arrangement a set of studs for use with a wheel can be provided.

At least one plastic injection moulded clip (not shown) is used to retain the base 4 against the rim of a wheel. The clip is designed to extend laterally across the base 4 to clip it to the rim. The base 4 may be provided with indents (not shown) to receive part of the surface of the or each clip to aid retention of the base 4 to the wheel rim.

In a further embodiment, the studs are formed as an integral part of the wheel, and the whole wheel is removed from the trolley and can be replaced with a traditional trolley wheel when the studs are no longer needed.

In a still further unillustrated embodiment, the base is formed as a continuous loop which is fitted directly over the wheel rim.

The described embodiments enable a golf course traversing vehicle to be used selectively during inclement or normal conditions without damaging the turf of the course. The studs hold the wheel rim away from the turf. The studs may penetrate the turf.

It will be appreciated that the foregoing is merely exemplary of apparatus in accordance with the invention and that modifications can readily be made thereto without departing from the scope of the invention as set out in the appended claims.

1. A vehicle wheel provided with a plurality of studs which extend radially from a rim of the wheel, the vehicle wheel being characterised in that at least some of the studs are parabolic or substantially parabolic in cross-section in a plane normal to the axis of the rotation of the wheel and generally parallel to the rolling direction of the wheel.

2. A vehicle wheel as claimed in claim 1 wherein all studs are parabolic or substantially parabolic.

3. A vehicle wheel as claimed in claim 1 in which each stud is paraboloid or substantially paraboloid in shape.

4. A vehicle wheel as claimed in claim 1 in which the studs are arranged in two rows which extend around the circumference of the wheel and which are spaced apart in an axial direction of the wheel.

5. A vehicle wheel as claimed in claim 4 in which the two rows are offset so that the studs in one row are substantially half-way along the gap between the studs in the adjacent row.

6. A vehicle wheel as claimed in claim 1 in which the length of each stud is between 20 mm and 45 mm in length.

7. A vehicle wheel as claimed in claim 6 in which the length of each stud is between 23 mm and 30 mm in length.

8. A vehicle wheel as claimed in claim 1 in which the width of each stud at the base is between 15 mm and 30 mm.

9. A vehicle wheel as claimed in claim 8 in which the width of each stud at the base is between 18 mm and 25 mm.

10. A vehicle wheel as claimed in claim 4 in which the two rows of studs are spaced apart in the axial direction of the wheel by substantially 30 mm to 50 mm.

11. A vehicle wheel as claimed in claim 10 in which the two rows of studs are spaced apart in the axial direction of the wheel by substantially 36 mm.

12. A vehicle wheel as claimed in claim 1 in which the studs in each row are spaced apart by substantially 35 mm to 80 mm.

13. A vehicle wheel as claimed in claim 12 in which the studs in each row are spaced apart by substantially 41 mm.

14. A vehicle wheel as claimed in claim 1 in which the studs are integrally formed with the wheel.

15. A vehicle wheel as claimed in claim 1 in which the studs are removable from the wheel.

16. A vehicle wheel as claimed in claim 1 in which the studs are provided on an elongate base which is adapted to be held in position against the rim of the wheel.

17. A vehicle wheel as claimed in claim 16 in which the base comprises a strip of resilient material.

18. A vehicle wheel as claimed in claim 17 in which the resilient strip is provided with attachment means adapted to attach one end of the base to the other around the wheel.

19. A vehicle as claimed in claim 18 in which the attachment means comprise the two opposing surfaces of a hook and loop fastener.

20. A vehicle wheel as claimed in claim 19 in which the ends of the base are angled at approximately 45 degrees to the sides.

21. A vehicle wheel as claimed in claim 20 in which the base and the studs are formed from a single piece of resilient material.

22. A vehicle wheel as claimed in claim 17 in which the base comprises a continuous loop of resilient material.

23. A vehicle wheel as claimed in claim 20 in which each stud comprises a base portion and a body portion, in which the base portion is provided with a male portion of an attachment means and the body portion is provided with a female portion of the attachment means, and in which the base portion and the body portion can be attached together with the male portion of the attachment means protruding through an aperture provided in the base.

24. A vehicle wheel as claimed in claim 23 in which the base is substantially the same dimensions as the outer peripheral rim surface of the wheel.

25. A vehicle wheel as claimed in claim 17 in which the base is between substantially 70 mm and 125 mm in width.

26. A vehicle wheel as claimed in claim 1 in which the wheel is adapted for use with a golf trolley.

27. A vehicle wheel as claimed in claim 1 in which the wheel is adapted to be used with a golf buggy or cart.

28. A set of studs for mounting on a vehicle wheel, each stud being characterised in that it is paraboloid or substantially paraboloid

29. A base for mounting on the rim of a vehicle wheel for use with a golf course traversing vehicle and including a plurality of studs upstanding from one surface of the base, the base being characterised in that when it is mounted on the rim of a vehicle wheel, the studs are parabolic in cross-section in a plane normal to the axis of the wheel and parallel to its rolling direction.

30. A golf course traversing vehicle provided with wheels, a set of studs or a base as claimed in claim 1.
